(19) United States
(12) Patent Application Publication
(10) Pub. No.: US 2020/0136818 A1
(43) Pub. Date: Apr. 30, 2020

(54) SYSTEM FOR GENERATING PERSONALIZED SERVICE CONTENT

(71) Applicant: INTERNATIONAL BUSINESS MACHINES CORPORATION, ARMONK, NY (US)

(72) Inventors: Shun JIANG, San Jose, CA (US); Xiaonan DUAN, Sunnyvale, CA (US); Aly MEGAHED, San Jose, CA (US); Ahmed NAZEEM, Fremont, CA (US)

(21) Appl. No.: 16/171,312

(22) Filed: Oct. 25, 2018

(51) Int. Cl. H04L 9/08; H04L 9/00; H04L 9/32; G06F 21/62

(52) U.S. Cl. CPC H04L 9/0866; H04L 9/008; G06F 21/32; G06F 21/6245; H04L 9/3231

(57) ABSTRACT

A system may include registration devices configured to generate, in a trusted environment, respective fully homomorphic encryption (FHE) biometric image registration records for first users. A registration data storage device may, in a non-trusted environment, store the FHE biometric image registration records and associated service context data. Capture devices may, in a less-trusted environment, generate respective FHE biometric image recognition records for second users at least partially overlapping the first users. A recognition data storage device may, in a non-trusted environment, store the FHE biometric image recognition records, and a recognition device, in a non-trusted environment, calculates encrypted distances between each FHE biometric image recognition and registration records, and retrieves respective service context data based upon the encrypted distances. Service provider devices may, in a non-trusted environment, generate personalized service content for the second plurality of users based upon the encrypted distances and the retrieved service context data.

### BACKGROUND

The present invention relates to biometrics, and more specifically, to providing content based upon biometric images. Image recognition and similarity measurement technology can be used to provide many services like identity based services. For example, an airport display board can be made passenger aware so it can recognize a passenger and highlight the flight information for the passengers who are standing in front of the display board looking for their flight information.

In many image recognition systems, images are processed through a deep neural network to first generate low dimensional embeddings, which are then used for tasks like clustering and classification. However, to find the images with similar features, for example, to tell whether two face images belong to the same person, embeddings may be generated on which the distance can be measured mathematically and which represents the similarity of faces.

With respect to biometric authentication frameworks, there exists client side and server side authentication. Client side authentication involves the storage of biometric information on a trusted personal device only. The biometric information is not distributed to a server.

Server side authentication involves the capturing of biometrics from client devices and the distribution of the biometrics to a server for storage. Authentication may be performed without involving client devices, for example, trusted client devices. However, storing biometric information on a server may not be desirable.

### SUMMARY

A system for generating personalized service content may include a plurality of registration devices configured to generate, in a trusted environment, respective fully homomorphic encryption (FHE) biometric image registration records for a first plurality of users. The system may also include a registration data storage device configured to, in a non-trusted environment, store the FHE biometric image registration records and associated service context data. The system may also include a plurality of capture devices configured to, in a less-trusted environment, generate respective FHE biometric image recognition records for a second plurality of users at least partially overlapping the first plurality of users, and a recognition data storage device configured to, in a non-trusted environment, store the FHE biometric image recognition records. The system may also include a recognition device configured to, in a non-trusted environment, calculate a plurality of encrypted distances between each FHE biometric image recognition record and the FHE biometric image registration records, and retrieve respective service context data for the FHE biometric image recognition records based upon the plurality of encrypted distances. The system may further include a plurality of service provider devices configured to, in a non-trusted environment, generate personalized service content for the second plurality of users based upon the plurality of encrypted distances and the retrieved service context data.

The system may include a protection device configured to, in a trusted environment, generate an encryption key. Each registration device may be configured to receive the service context data, capture and extract biometric image features, and encrypt the biometric image features using the encryption key to generate each FHE biometric image registration record, for example. Each capture device may be configured to capture and extract biometric image features, and encrypt the biometric image features using the encryption key to generate each FHE biometric image recognition record, for example.

The recognition device may be configured to retrieve respective service context data for the FHE biometric image recognition records based upon a plurality of lowest encrypted distances. The recognition device may be configured to generate a respective index corresponding to each of the plurality of lowest encrypted distances, and the plurality of service provider devices may be configured to generate the personalized service content for the second plurality of users based upon the respective indexes, for example. The system may include a protection device in a trusted environment, and the recognition device may be configured to communicate the plurality of encrypted distances to the protection device.

The plurality of capture devices may include at least one camera. The system may further include a display cooperating with a respective one of the plurality of service provider devices to display the respective personalized service content, for example.

The recognition device may be configured to retrieve respective service context data for the FHE biometric image recognition records using deep learning based upon the plurality of encrypted distances. The service context data may include geographical location data, for example.

A method aspect is directed to a method of generating personalized service content. The method may include using a registration data storage device to, in a non-trusted environment, store fully homomorphic encryption (FHE) biometric image registration records and associated service context data. Respective FHE biometric image registration records may be generated for a first plurality of users, in a trusted environment, by a plurality of registration devices. The method may also include using a recognition data storage device to, in a non-trusted environment, store FHE biometric image recognition records. Respective FHE biometric image recognition records may be generated for a second plurality of users at least partially overlapping the first plurality of users, in a less-trusted environment, by a plurality of capture devices. The method may also include using a recognition device to, in a non-trusted environment, calculate a plurality of encrypted distances between each FHE biometric image recognition record and the FHE biometric image registration records, and retrieve respective service context data for the FHE biometric image recognition records based upon the plurality of encrypted distances so that a plurality of service provider devices, in a non-trusted environment, generate the personalized service content for the second plurality of users based upon the plurality of encrypted distances and the retrieved service context data.

A computer readable medium aspect is directed to a computer readable medium for generating personalized service content. The computer readable medium includes computer executable instructions that when executed by a processor cause the processor to perform operations. The operations may include, in a non-trusted environment, storing fully homomorphic encryption (FHE) biometric image registration records and associated service context data in a registration data storage device, respective FHE biometric image registration records being generated for a first plurality of users, in a trusted environment, by a plurality of registration devices. The operations may also include, in a non-trusted environment, storing FHE biometric image recognition records in a recognition data storage device, respective FHE biometric image recognition records being generated for a second plurality of users at least partially overlapping the first plurality of users, in a less-trusted environment, by a plurality of capture devices. The operations may further include, in a non-trusted environment, calculating a plurality of encrypted distances between each FHE biometric image recognition record and the FHE biometric image registration records, and retrieving respective service context data for the FHE biometric image recognition records based upon the plurality of encrypted distances so that a plurality of service provider devices, in a non-trusted environment, generate the personalized service content for the second plurality of users based upon the plurality of encrypted distances and the retrieved service context data.

### BRIEF DESCRIPTION OF THE DRAWINGS

FIG. 1 is a diagram illustrating an exemplary implementation of a system for generating personalized service content in accordance with an embodiment.

FIG. 2 is a schematic diagram of a system for generating personalized service content in accordance with an embodiment.

FIG. 3 is a more detailed schematic diagram of a portion of the system of FIG. 2.

FIG. 4 is a flow diagram illustrating biometric image registration operations in accordance with an embodiment.

FIG. 5 is a flow diagram illustrating biometric capture operations in accordance with an embodiment.

FIG. 6 is a flow diagram illustrating biometric recognition operations in accordance with an embodiment.

### DETAILED DESCRIPTION

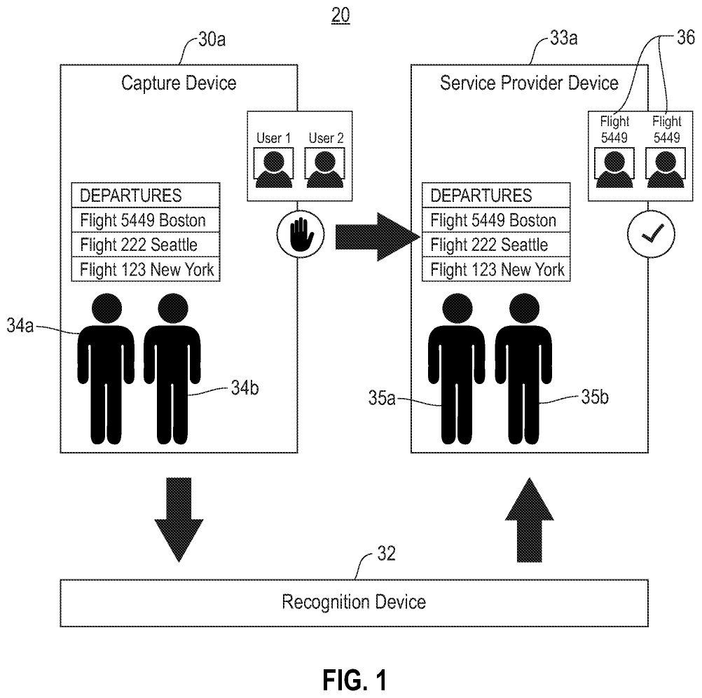

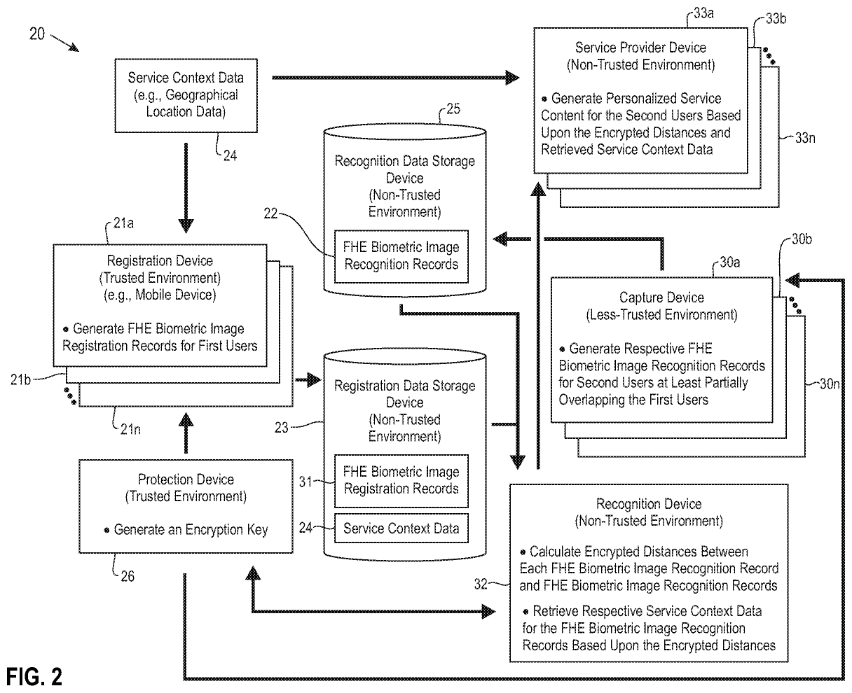

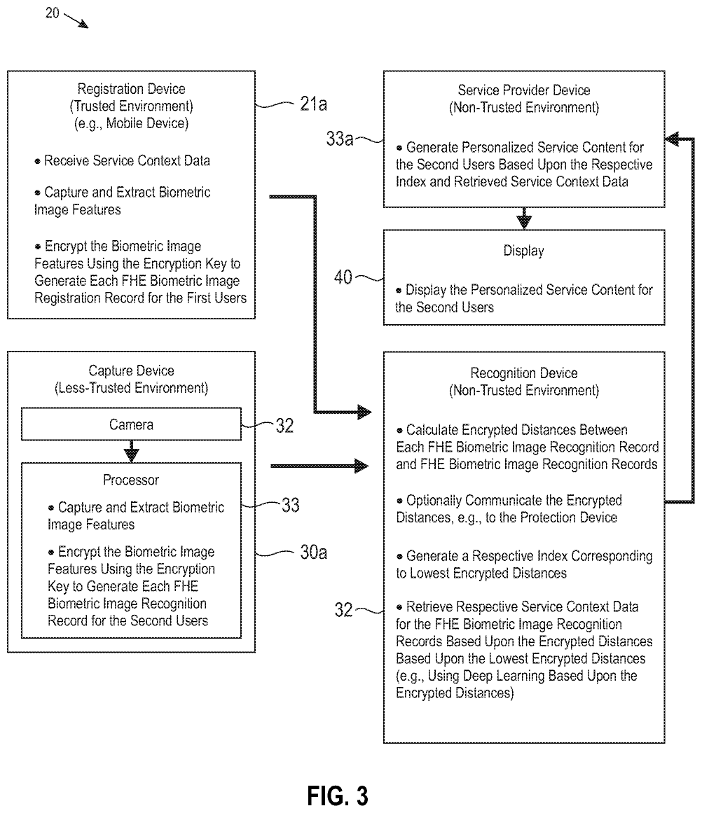

Referring initially to FIGS. 1-3, a system 20 may include registration devices 21a-21n. Registration devices 21a-21n may be in the form of mobile wireless communications devices, for example, smartphones, etc. Of course, the registration devices 21a-21n may be a different type of device, for example, a desktop computer, tablet, or other device associated with respective users. The registration devices 21a-21n generate, in a trusted environment, respective fully homomorphic encryption (FHE) biometric image registration records 31 for first users 34a, 34b. The FHE biometric image registration records 31 may be facial recognition or facial image records, for example, and be acquired by a camera associated with the respective registration device 21a-21n.

A protection device 26, which operates in a trusted environment, generates an encryption key. More particularly, with respect to the registration devices 21a-21n, each registration device receives service context data 24, captures and extracts biometric image features, and encrypts the biometric image features using the encryption key to generate each FHE biometric image registration record 31. The service context data 24 may include geographical location data, for example. The service context data 24 may include other and/or additional types of data. A registration data storage device 23, in a non-trusted environment, stores the FHE biometric image registration records 31 and associated service context data 24.

Capture devices 30a-30n, which are in a less-trusted environment, generate respective FHE biometric image recognition records 22 for second users 35a, 35b. The second users 35a, 35b at least partially overlapping the first users 34a, 34b. In other words, there are common users among the first 34a, 34b and second users 35a, 35b. Each capture device 30a-30n may include a camera 32 coupled to a processor 33. Each capture device 30a-30n may include more than one camera 32, for example.

Each capture device 30a-30n captures and extracts biometric image features, and encrypts the biometric image features using the encryption key to generate each FHE biometric image recognition record 22. A recognition data storage device 25, in a non-trusted environment, stores the FHE biometric image recognition records 22.

A recognition device 32, in a non-trusted environment, calculates encrypted distances between each FHE biometric image recognition record 22 and the FHE biometric image registration records 31, and retrieves respective service context data 24 for the FHE biometric image recognition records based upon the encrypted distances. More particularly, the recognition device 32 retrieves the respective service context data 24 for the FHE biometric image recognition records 22 based upon the lowest encrypted distances. The recognition device 32 may retrieve the service context data 24 for the FHE biometric image recognition records 22 using deep learning based upon the encrypted distances, for example. A respective index corresponding to each of the lowest encrypted distances may also generated by the recognition device 32.

Service provider devices 33a-33n, in a non-trusted environment, generate personalized service content 36 for the second users 35a, 35b based upon the encrypted distances and the retrieved service context data 24. When the recognition device 32 generates respective indices, the service provider devices 33a-33n generate the personalized service content 36 for the second users 35a, 35b based upon the respective index. A display 40 cooperates with a respective service provider device 33a-33n to display the personalized service content 36 for the second users 35a, 35b.

In an exemplary implementation, a given registration device 21a may be a mobile phone associated with a user 34a, 34b. A given capture device 30a may be located at an airport and may be implemented with a display 41, for example, of flight data (FIG. 1). Based upon facial image recognition of the users 34a, 34b at the display 41 or capture device 30a, flight data (i.e., personalized service content 36) may be displayed for the users. In other words, when the users 34a, 34b approach the display 41 or capture device 30a, relevant information personalized to the users is displayed, for example, their respective flight statuses.

As will be appreciated by those skilled in the art, biometric based identity services may be relatively convenient to users at public locations, e.g. at the airport as described above.

However many users may have privacy concerns. In many cases, a passenger may not be willing to share their biometric information, for example, prior to its usage for a given function. In such use cases, authentication involving a passenger's personal device may not be ideal, and a personalized service provider and/or the display board, should not access the passenger profile. Instead, it is desirable to access only required information for the service it provides—i.e. flight information of the passengers as in the present example. The system 20 described herein advantageously provides multiple components, each having different security criteria, for example. Since the different components of the system 20 do not cooperate to disclose user's privacy, then no single component can recover the complete information, i.e. user's registration embedding, service context and the actual location where the user is recognized.

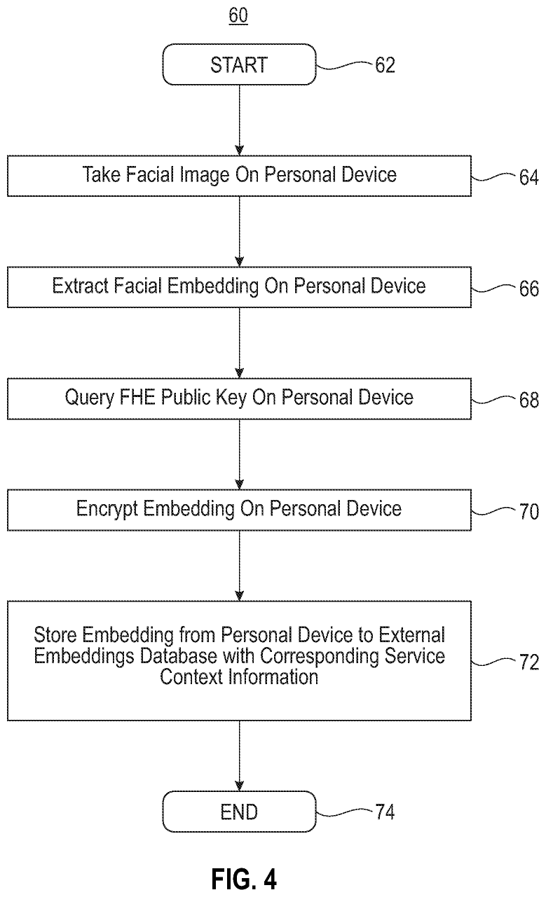

Referring now additionally to the flowchart 60 in FIG. 4, beginning at Block 62, further details of a user registration process will now be described. At Block 64, a trusted end user or registration device 21a (e.g., a personal mobile device with a corresponding application; in a trusted environment) captures one or more facial images of the corresponding user 34a, 34b, and, at Block 66, biometric features are extracted into an embedding using a model. A trusted FHE based embedding service provider (e.g., the protection device 26) securely manages a public/private key pair. The encryption key will be distributed to external parties, as will be appreciate by those skilled in the art.

At Block 68, the user requests or queries the public key from the embedding service provider or protection device 26 and encrypts the embedding (Block 70). The encrypted embedding is combined with service context data 24 (e.g. flight information in the given implementation example), which are then distributed to a public database, for example, the registration storage device 23 (Block 72). The public database or registration storage device 23 stores the encrypted embeddings from end user registration process as described above. The data stored in this database can be queried by external parties without exposing the user face information since the embeddings are encrypted. The registration process ends at Block 74.

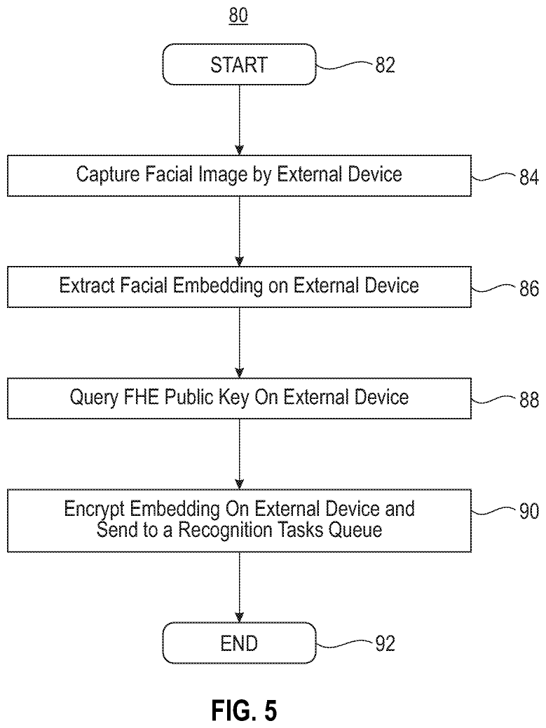

Referring to the flowchart 80 in FIG. 5, further details of capturing and recognition will now be described. Beginning at Block 82, when a user 34a, 34b arrives at a location deployed with facial recognition applications, a capture device 30a captures the face images of the user (Block 84) and extracts biometric features into embeddings using a model (Block 86), for example, the same model used in the registration process described above. The extracted embeddings are encrypted, for example, using the FHE public key, and combined with device metadata information (Block 88). The encrypted embeddings are distributed into a queue as facial recognition requests, for example, at the recognition data storage device 25 (Block 90). The capturing process ends at Block 92.

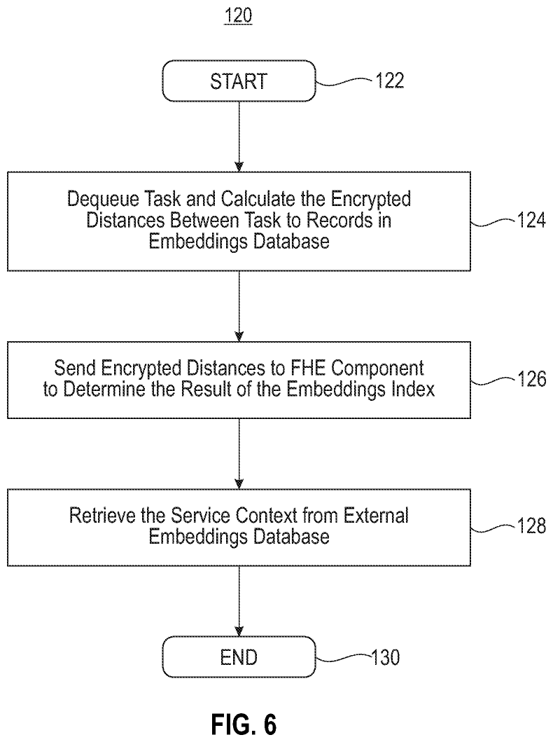

Referring now to the flowchart 120 in FIG. 6, further details of recognition will now be described. Beginning at Block 122, the queue or recognition data storage device 25 queues the facial recognition requests made by one or many facial recognition service providers, e.g., service provider devices 33a-33n. The recognition device 32, for example, based upon a query from the service provider devices 33a-33n, queries from the recognition data storage device 25 for all available encrypted embeddings and calculates the distances to embeddings de-queued from the recognition data storage device, for example, a given encrypted embedding (Block 124). The result is a list of encrypted distances. The recognition device 32 may send the encrypted distances to an FHE component, e.g., cooperating with the protection device 26, to determine the result of an embedding index (Block 126). The service context data 24 associated with the lowest distance index is returned and provided to the corresponding service provider device 33a-33n to generate the personalized content (Block 128). In other words, the lowest distance indexed service context is used by the personalized service to determine the information to deliver according to the service definition. Thus, the system 20 advantageously delivers the personalized service content 36 or the personalized service without exposing the biometric identity information of the user. The recognition operations end at Block 130.

As will be appreciated by those skilled in the art, the system 20 addresses various levels of security and/or data privacy concerns. The system 20 does not distribute user facial or biometric images. The system 20 is separated into multiple components each having different security criteria. The different components maintain or do not disclose biometric image data so that a single component cannot generally recover a user's complete biometric profile or information (e.g., the user's registration embedding, the service context, and the actual location where the user is recognized). Moreover, the system 20 operates to cover multi-tenants and differentiates the attributes of the multi-tenants.

A method aspect is directed to a method of generating personalized service content 36. The method includes using a registration data storage device 23 to, in a non-trusted environment, store FHE biometric image registration records 31 and associated service context data 24. Respective FHE biometric image registration records 31 may be generated for a first plurality of users 34a, 34b, in a trusted environment, by a plurality of registration devices 21a-21n. The method also includes using a recognition data storage device 25 to, in a non-trusted environment, store FHE biometric image recognition records 22. Respective FHE biometric image recognition records 22 may be generated for a second plurality of users 35a, 35b at least partially overlapping the first plurality of users 34a, 34b, in a less-trusted environment, by a plurality of capture devices 30a-30n. The method also includes using a recognition device 32 to, in a non-trusted environment, calculate a plurality of encrypted distances between each FHE biometric image recognition record 22 and the FHE biometric image registration records 31, and retrieve respective service context data 24 for the FHE biometric image recognition records based upon the plurality of encrypted distances so that a plurality of service provider devices 33a-33n, in a non-trusted environment, generate the personalized service content 36 for the second plurality of users 35a, 35n based upon the plurality of encrypted distances and the retrieved service context data.

A computer readable medium aspect is directed to a computer readable medium for generating personalized service content 36. The computer readable medium includes computer executable instructions that when executed by a processor 33 cause the processor to perform operations. The operations include, in a non-trusted environment, storing FHE biometric image registration records 31 and associated service context data 24 in a registration data storage device 23, respective FHE biometric image registration records being generated for a first plurality of users 34a, 34b, in a trusted environment, by a plurality of registration devices. The operations also include, in a non-trusted environment, storing FHE biometric image recognition records 22 in a recognition data storage device 25, respective FHE biometric image recognition records being generated for a second plurality of users 35a, 35b at least partially overlapping the first plurality of users 34a, 34b, in a less-trusted environment, by a plurality of capture devices 30a-30n. The operations further include, in a non-trusted environment, calculating a plurality of encrypted distances between each FHE biometric image recognition record 22 and the FHE biometric image registration records 31, and retrieving respective service context data 24 for the FHE biometric image recognition records based upon the plurality of encrypted distances so that a plurality of service provider devices 33a-33n, in a non-trusted environment, generate the personalized service content 36 for the second plurality of users 35a, 35b based upon the plurality of encrypted distances and the retrieved service context data.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While functions herein are described with respect to the various components of the system 20, it will be appreciated by those skilled in the art that the functions are performed based upon cooperation of respective processors and memories. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for generating personalized service content comprising:
a plurality of registration devices configured to generate, in a trusted environment, respective fully homomorphic encryption (FHE) biometric image registration records for a first plurality of users;
a registration data storage device configured to, in a non-trusted environment, store the FHE biometric image registration records and associated service context data;
a plurality of capture devices configured to, in a less-trusted environment, generate respective FHE biometric image recognition records for a second plurality of users at least partially overlapping the first plurality of users;
a recognition data storage device configured to, in a non-trusted environment, store the FHE biometric image recognition records;
a recognition device configured to, in a non-trusted environment, calculate a plurality of encrypted distances between each FHE biometric image recognition record and the FHE biometric image registration records, and retrieve respective service context data for the FHE biometric image recognition records based upon the plurality of encrypted distances; and
a plurality of service provider devices configured to, in a non-trusted environment, generate personalized service content for the second plurality of users based upon the plurality of encrypted distances and the retrieved service context data.

2. The system of claim 1 comprising a protection device configured to, in a trusted environment, generate an encryption key; and wherein each registration device is configured to receive the service context data, capture and extract biometric image features, and encrypt the biometric image features using the encryption key to generate each FHE biometric image registration record.

3. The system of claim 1 comprising a protection device configured to, in a trusted environment, generate an encryption key; and wherein each capture device is configured to capture and extract biometric image features, and encrypt the biometric image features using the encryption key to generate each FHE biometric image recognition record.

4. The system of claim 1 wherein the recognition device is configured to retrieve respective service context data for the FHE biometric image recognition records based upon a plurality of lowest encrypted distances.

5. The system of claim 4 wherein the recognition device is configured to generate a respective index corresponding to each of the plurality of lowest encrypted distances; and wherein the plurality of service provider devices is configured to generate the personalized service content for the second plurality of users based upon the respective indexes.

6. The system of claim 1 comprising a protection device in a trusted environment; and wherein the recognition device is configured to communicate the plurality of encrypted distances to the protection device.

7. The system of claim 1 wherein the plurality of capture devices comprises at least one camera.

8. The system of claim 1 further comprising a display cooperating with a respective one of the plurality of service provider devices to display respective personalized service content.

9. The system of claim 1 wherein the recognition device is configured to retrieve respective service context data for the FHE biometric image recognition records using deep learning based upon the plurality of encrypted distances.

10. The system of claim 1 wherein the service context data comprises geographical location data.

11. A method of generating personalized service content, the method comprising:
using a registration data storage device to, in a non-trusted environment, store fully homomorphic encryption (FHE) biometric image registration records and associated service context data, respective FHE biometric image registration records being generated for a first plurality of users, in a trusted environment, by a plurality of registration devices;
using a recognition data storage device to, in a non-trusted environment, store FHE biometric image recognition records, respective FHE biometric image recognition records being generated for a second plurality of users at least partially overlapping the first plurality of users, in a less-trusted environment, by a plurality of capture devices; and
using a recognition device to, in a non-trusted environment, calculate a plurality of encrypted distances between each FHE biometric image recognition record and the FHE biometric image registration records, and retrieve respective service context data for the FHE biometric image recognition records based upon the plurality of encrypted distances so that a plurality of service provider devices, in a non-trusted environment, generate the personalized service content for the second plurality of users based upon the plurality of encrypted distances and the retrieved service context data.

12. The method of claim 11 further comprising using a protection device to, in a trusted environment, generate an encryption key; and wherein each registration device receives the service context data, captures and extracts biometric image features, and encrypts the biometric image features using the encryption key to generate each FHE biometric image registration record.

13. The method of claim 11 further comprising using a protection device to, in a trusted environment, generate an encryption key; and wherein each capture device is configured to capture and extract biometric image features, and encrypt the biometric image features using the encryption key to generate each FHE biometric image recognition record.

14. The method of claim 11 wherein using the recognition device comprises using the recognition device to retrieve respective service context data for the FHE biometric image recognition records based upon a plurality of lowest encrypted distances.

15. The method of claim 14 wherein using the recognition device comprises using the recognition device to generate a respective index corresponding to each of the plurality of lowest encrypted distances; and wherein the plurality of service provider devices generate the personalized service content for the second plurality of users based upon the respective indexes.

16. The method of claim 11 wherein using the recognition device comprises using the recognition device to retrieve respective service context data for the FHE biometric image recognition records using deep learning based upon the plurality of encrypted distances.

17. A computer readable medium for generating personalized service content, the computer readable medium comprising computer executable instructions that when executed by a processor cause the processor to perform operations comprising:
in a non-trusted environment, storing fully homomorphic encryption (FHE) biometric image registration records and associated service context data in a registration data storage device, respective FHE biometric image registration records being generated for a first plurality of users, in a trusted environment, by a plurality of registration devices;
in a non-trusted environment, storing FHE biometric image recognition records in a recognition data storage device, respective FHE biometric image recognition records being generated for a second plurality of users at least partially overlapping the first plurality of users, in a less-trusted environment, by a plurality of capture devices; and
in a non-trusted environment, calculating a plurality of encrypted distances between each FHE biometric image recognition record and the FHE biometric image registration records, and retrieving respective service context data for the FHE biometric image recognition records based upon the plurality of encrypted distances so that a plurality of service provider devices, in a non-trusted environment, generate the personalized service content for the second plurality of users based upon the plurality of encrypted distances and the retrieved service context data.

18. The computer readable medium of claim 17 wherein the operations comprise, in a trusted environment, generating an encryption key; and wherein each registration device receives the service context data, capture and extract biometric image features, and encrypt the biometric image features using the encryption key to generate each FHE biometric image registration record.

19. The computer readable medium of claim 17 wherein the operations comprise, in a trusted environment, generating an encryption key; and wherein each capture device is configured to capture and extract biometric image features, and encrypt the biometric image features using the encryption key to generate each FHE biometric image recognition record.

20. The computer readable medium of claim 17 wherein the operations comprise retrieving respective service context data for the FHE biometric image recognition records based upon a plurality of lowest encrypted distances.
